(19) United States
(12) Patent Application Publication
(10) Pub. No.: US 2024/0151955 A1
(43) Pub. Date: May 9, 2024

(54) IMAGE PROJECTION DEVICE

(71) Applicant: KOITO MANUFACTURING CO., LTD., Tokyo (JP)

(72) Inventors: Kazuomi MURAKAMI, Shizuoka-shi, Shizuoka (JP); Takuo SUGIYAMA, Shizuoka-shi, Shizuoka (JP)

(73) Assignee: KOITO MANUFACTURING CO., LTD., Tokyo (JP)

(21) Appl. No.: 18/279,507

(22) PCT Filed: Mar. 25, 2022
(86) PCT No.: PCT/JP2022/014434

§ 371 Date: Aug. 30, 2023

(30) Foreign Application Priority Data
Mar. 31, 2021 (JP) 2021-059579

(51) Int. Cl. G02B 17/06; B60K 35/23; G02B 27/01

(52) U.S. Cl. CPC G02B 17/0621; B60K 35/23; G02B 27/0101

(57) ABSTRACT

An image projection device that can effectively use a space to achieve space saving even when projection light from an image projecting unit is reflected by a plurality of freeform curved mirrors to reach a viewpoint is provided. The image projection device includes: an image projecting unit emitting projection light including an image; a first freeform curved mirror reflecting the projection light incident from the image projecting unit; and a second freeform curved mirror reflecting the projection light incident from the first freeform curved mirror and causing the projection light to reach a viewpoint. Only one of an x-axis component and a y-axis component of the projection light reflected by the first freeform curved mirror forms an image between the first freeform curved mirror and the second freeform curved mirror.

### TECHNICAL FIELD

The invention relates to an image projection device and particularly to an image projection device that causes projection light from an image projecting unit to be reflected by a plurality of freeform curved mirrors and to reach a viewpoint.

### BACKGROUND ART

In the related art, an instrument panel displaying an icon by lighting is used as a device displaying various kinds of information in a vehicle. With an increase in an amount of information to be displayed, it has also been proposed that an image display device be embedded in the instrument panel or the whole instrument panel is configured as an image display device.

However, since the instrument panel is located below the front glass (a windshield) of the vehicle, a driver needs to move a sight line to below during driving in order to see information displayed on the instrument panel, which is not desirable. Therefore, an image projection device such as a head-up display (hereinafter referred to as an HUD) that can allow a driver to read information when seeing the front of the vehicle by projecting an image to the front glass has been proposed (for example, see Patent Literature 1).

In such an image projection device according to the related art, an image projecting unit emits projection light including an image, causes one or more freeform curved mirrors to reflect the projection light, and causes the projection light to reach a viewpoint position of a driver or the like such that the image is formed in a space. Accordingly, the driver or the like can recognize the image as if the image were displayed at an imaging position in a depth direction by the projection light being incident on the viewpoint.

### CITATION LIST

### Patent Literature

[Patent Literature 1] Japanese Unexamined Patent Application Publication No. 2019-119262 (JP 2019-119262 A)

### SUMMARY OF THE INVENTION

However, in the image projection device according to the related art, since a plurality of freeform curved mirrors need to be alternately arranged to face each other and a space needs to be secured such that a member such as the image projecting unit does not block light reflected by the freeform curved mirrors, it is difficult to achieve space saving. When the size of the freeform curved mirrors is decreased to achieve space saving, there is a problem in that the curvature of the freeform curved mirrors increases and thus an aberration increases.

Therefore, the invention was made in consideration of the problems in the related art and provides an image projection device that can effectively use a space to achieve space saving even when projection light from an image projecting unit is reflected by a plurality of freeform curved mirrors to reach a viewpoint.

In order to solve the aforementioned problem, according to the invention, there is provided an image projection device including: an image projecting unit emitting projection light including an image; a first freeform curved mirror reflecting the projection light incident from the image projecting unit; and a second freeform curved mirror reflecting the projection light incident from the first freeform curved mirror and causing the projection light to reach a viewpoint, wherein, when an optical path of the projection light from the image projecting unit to the viewpoint is defined as a reference light beam, a reflection direction of the reference light beam from the first freeform curved mirror is defined as a z axis, a direction perpendicular to the z axis in a plane including the reference light beam and the z axis in the second freeform curved mirror is defined as a y axis, and a direction perpendicular to the y axis and the z axis is defined as an x axis, only one of an x-axis component and a y-axis component of the projection light reflected by the first freeform curved mirror forms an image between the first freeform curved mirror and the second freeform curved mirror.

In the image projection device according to the invention, since the first freeform curved mirror causes only one of the x-axis component and the y-axis component to form an image between the first freeform curved mirror and the second freeform curved mirror, it is possible to secure a space in which an optical member is disposed in a space between the first freeform curved mirror and the second freeform curved mirror and to effectively use the space to achieve space saving.

In an aspect of the invention, the y-axis component may form an image between the first freeform curved mirror and the second freeform curved mirror.

In an aspect of the invention, an imaging position of the projection light reflected by the second freeform curved mirror may be the same for the x-axis component and the y-axis component.

In an aspect of the invention, the image projecting unit may be disposed at a position other than an area in which the projection light propagates between the first freeform curved mirror and the second freeform curved mirror.

In an aspect of the invention, the image projection device may further include a transmission and reflection part reflecting the projection light incident on one surface from the second freeform curved mirror toward the viewpoint and transmitting external light incident on another surface toward the viewpoint.

In an aspect of the invention, the transmission and reflection part may be a windshield of a vehicle.

According to the invention it is possible to provide an image projection device that can effectively use a space to achieve space saving even when projection light from the image projecting unit is reflected by a plurality of freeform curved mirrors to reach a viewpoint.

### BRIEF DESCRIPTION OF THE DRAWINGS

FIG. 1 is a diagram schematically illustrating a configuration of an image projection device according to a first embodiment of the invention, where FIG. 1(a) is a schematic top view and FIG. 1(b) is a schematic side view.

FIG. 2 is a diagram schematically illustrating arrangement of optical members and a reference light beam in the image projection device according to the first embodiment.

FIG. 3 is a diagram schematically illustrating a reference light beam and a local coordinate system in freeform curved mirrors, where FIG. 3(a) illustrates a freeform curved mirror 20 and FIG. 3(b) illustrates a freeform curved mirror 30.

FIG. 4 is a diagram schematically illustrating arrangement of an image projecting unit 10 and the freeform curved mirrors 20 and 30 according to the first embodiment, where FIG. 4(a) is a schematic side view and FIG. 4(b) is a schematic top view.

FIG. 5 is a diagram schematically illustrating arrangement of an image projecting unit 10 and freeform curved mirrors 20 and 30 according to a second embodiment, where FIG. 5(a) is a schematic side view and FIG. 5(b) is a schematic top view.

### MODES FOR CARRYING OUT THE INVENTION

### First Embodiment

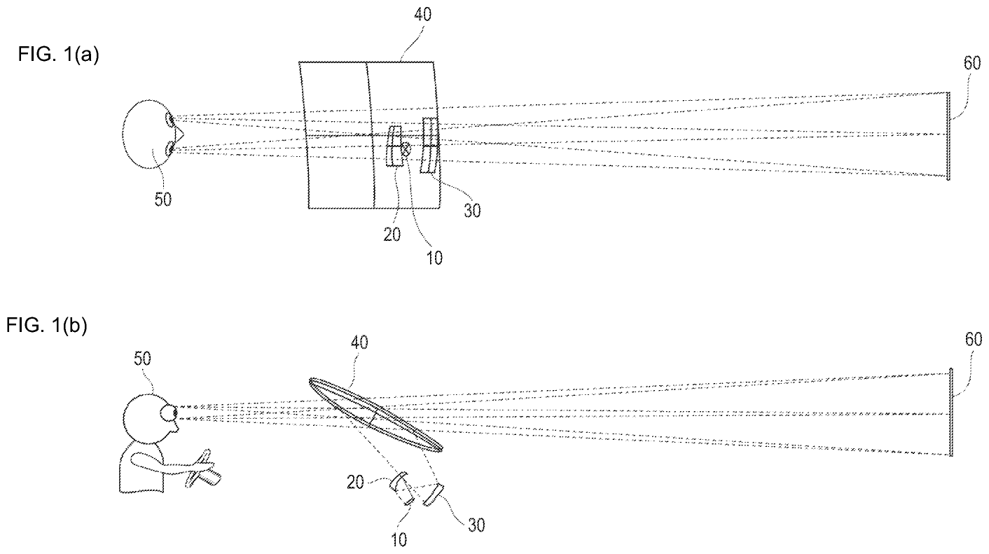

Hereinafter, an embodiment of the invention will be described in detail with reference to the accompanying drawings. The same or corresponding elements, members, and processes in the drawings will be referred to by the same reference signs and repeated description thereof will be appropriately omitted. FIG. 1 is a diagram schematically illustrating a configuration of an image projection device according to this embodiment, where FIG. 1(a) is a schematic top view and FIG. 1(b) is a schematic side view. As illustrated in FIG. 1, the image projection device includes an image projecting unit 10, freeform curved mirrors 20 and 30, and a windshield 40 and enables a virtual image 60 to be seen at a position of a viewpoint 50 via the windshield 40.

The image projecting unit 10 is a device that emits projection light including image information in response to supply of a signal including the image information from an information processing unit (not illustrated). Projection light emitted from the image projecting unit 10 is incident on the freeform curved mirror 20. Examples of the image projecting unit 10 include a liquid crystal display device, an organic EL display device, a micro LED display device, and a projector device using a laser light source.

The freeform curved mirror 20 is a concave mirror on which projection light emitted from the image projecting unit 10 is incident and which reflects the incident projection light to the freeform curved mirror 30, and corresponds to a first freeform curved mirror in the invention. A reflective surface of the freeform curved mirror 20 is set such that focal distances for an x-axis component and a y-axis component in the surface are different and only one of the x-axis component and the y-axis component intermediately form an image before the components reach the freeform curved mirror 30 as will be described later.

The freeform curved mirror 30 is a concave mirror on which projection light reflected by the freeform curved mirror 20 is incident and which reflects the incident projection light to the windshield 40, and corresponds to a second freeform curved mirror in the invention. A reflective surface of the freeform curved mirror 30 is also set such that focal distances for an x-axis component and a y-axis component in the surface are different and the x-axis component and the y-axis component form an image at the same position after the components have been reflected by the freeform curved mirror 30.

The windshield 40 is provided in front of a driver's seat of the vehicle and has a function of an optical member reflecting projection light incident from the freeform curved mirror 30 toward the viewpoint 50 and transmitting light from the outside of the vehicle toward the viewpoint 50 on the surface inside of the vehicle. Accordingly, the windshield 40 corresponds to a transmission and reflection part in the invention. Herein, an example in which the windshield 40 is used as the transmission and reflection part is described, but a combiner may be provided as the transmission and reflection part separately from the windshield 40 such that light from the freeform curved mirror 30 is reflected toward the viewpoint 50. The transmission and reflection part is not limited to the location on the front side of the vehicle and may be provided on a lateral side or the rear side as long as it projects an image to the viewpoint 50 of an occupant.

The viewpoint 50 is an eye (an eye box) of a driver or an occupant of the vehicle, and the driver or the occupant visually recognizes a formed virtual image 60 when projection light is incident on the eye box and reaches the retina.

The virtual image 60 is displayed to be formed in a space when projection light reflected by the windshield 40 reaches the viewpoint (eye box) 50 of the driver or the like. The position at which the virtual image 60 is formed is determined by a spread angle when light emitted from the image projecting unit 10 propagates to the viewpoint 50 after the light has been reflected by the freeform curved mirror 20 and the freeform curved mirror 30. As illustrated in FIGS. 1(a) and 1(b), projection light reflected by the freeform curved mirror 30 is reflected by the windshield 40 and then reaches the viewpoint 50 while a light beam is spreading.

At this time the driver or the occupant of the viewpoint 50 recognizes the virtual image 60 as if it were present at an imaging position farther than the windshield 40. Here, the imaging position of the virtual image 60 mainly depends on a combined focal distance of the freeform curved mirror 20 and the freeform curved mirror 30. Even when the windshield 40 does not have a flat surface but a curved surface, the radius of curvature is larger than those of the freeform curved mirror 20 and the freeform curved mirror 30 and thus an influence of an optical power of the windshield 40 can be ignored.

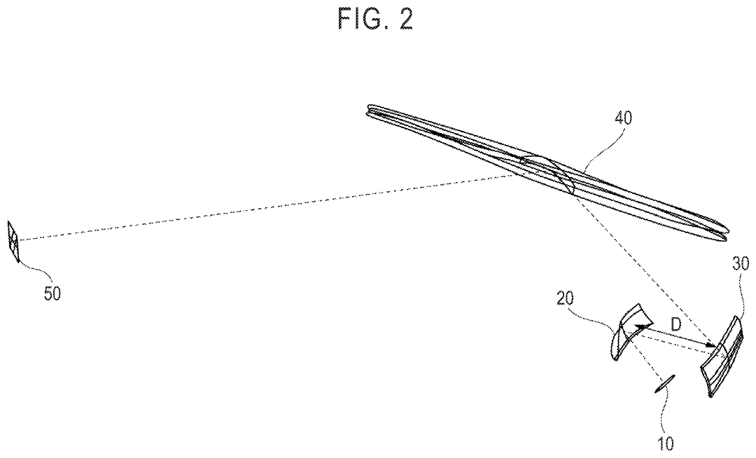

FIG. 2 is a diagram schematically illustrating arrangement of optical members and a reference light beam in the image projection device according to this embodiment. As illustrated in FIG. 2, projection light emitted from the image projecting unit 10 is reflected by the freeform curved mirrors 20 and 30 and the windshield 40 and reaches the viewpoint 50. At this time, a locus of light reaching the viewpoint 50 in the direction in which the virtual image 60 is seen is defined as a reference light beam and is indicated by a dotted line in FIG. 2. In other words, the reference light beam can be considered to be substantially the same as a locus of light emitted from the center of an effective area from which light is emitted in the image projecting unit 10 until the light reaches the viewpoint 50. Actual projection light is light which is emitted with a predetermined area from the image projecting unit 10 and of which a light beam spreads from positions of an display surface thereof, and is focused with a positive power of the reflective surfaces of the freeform curved mirror 20 and the freeform curved mirror 30. Accordingly, the reference light beam illustrated in FIG. 2 does not indicate a path along which projection light propagates in the entire area of the image projecting unit 10. A distance from the freeform curved mirror 20 to the freeform curved mirror 30 along the reference light beam is defined as D.

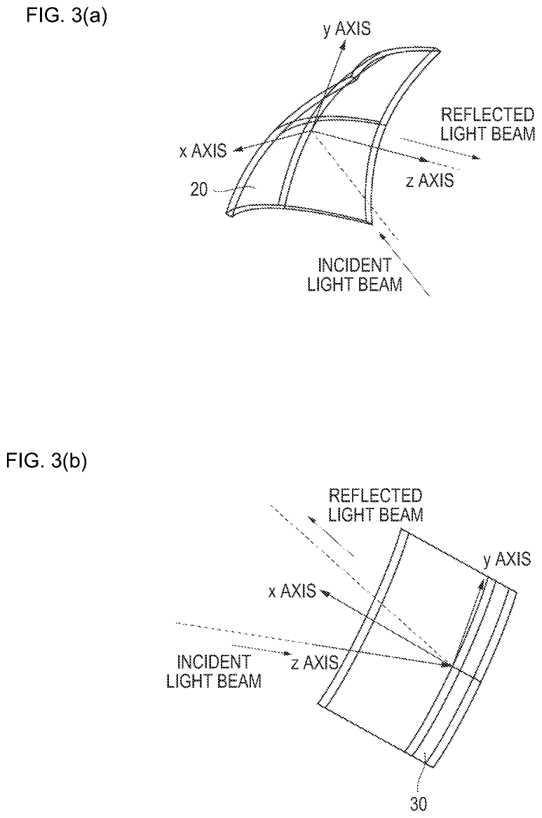

FIG. 3 is a diagram schematically illustrating a reference light beam and a local coordinate in the freeform curved mirrors, where FIG. 3(a) illustrates the freeform curved mirror 20 and FIG. 3(b) illustrates the freeform curved mirror 30. A dotted line illustrated in FIGS. 3(a) and 3(b) is the reference light beam of projection light indicated by the dotted line in FIG. 2. The reference light beam in a direction in which projection light is incident on the freeform curved mirror 20 and the freeform curved mirror 30 is defined as an incident light beam, and the reference light beam in a direction in which projection light is reflected from the freeform curved mirror 20 and the freeform curved mirror 30 is defined as a reflected light beam.

As illustrated in FIGS. 3(a) and 3(b), the reflection direction of the reference light beam in the freeform curved mirror 20 is defined as a z axis. A direction perpendicular to the z axis in a plane including the reflection direction of the reference light beam and the z axis in the freeform curved mirror 30 is defined as a y axis. A direction perpendicular to the y axis and the z axis is defined as an x axis.

The freeform curved mirror 20 includes a curved surface having different curvatures in the x-axis direction and the y-axis direction, projection light reflected therefrom is focused on focal distances which are different in an x-axis component and a y-axis component, and only one of the x-axis component and the y-axis component intermediately forms an image between the freeform curved mirror 20 and the freeform curved mirror 30. In the example illustrated in FIG. 1, a substantially horizontal direction of the vehicle is the x-axis direction, and a substantially vertical direction is the y-axis direction. Accordingly, only one of the x-axis component which is the horizontal direction of the vehicle and the y-axis component which is the vertical direction of the projection light intermediately forms an image.

Here, when parallel light is incident on the freeform curved mirror 20 from the image projecting unit 10 and a distance to a position on which light subjected to the positive power by the freeform curved mirror 20 is focused is defined as a focal distance f1, a focal distance of the x-axis component is defined as fx1 and the focal distance of the y-axis component is defined as fy1. Accordingly, a relationship 0<fy1≤D≤fx1 or 0<fx1≤D≤fy1 is satisfied when compared along with the distance D between the freeform curved mirror 20 and the freeform curved mirror 30 along the reference light beam.

Similarly, the freeform curved mirror 30 also includes a curved surface having different curvatures in the x-axis direction and the y-axis direction and the projection light reflected therefrom has different focal distances for the x-axis component and the y-axis component. Here, when parallel light is incident on the freeform curved mirror 30 and a distance to a position on which light subjected to the positive power by the freeform curved mirror 30 is focused is defined as a focal distance f2, a focal distance of the x-axis component is defined as fx2 and the focal distance of the y-axis component is defined as fy2.

As described above, the focal distance fx1 and the focal distance fy1 in the freeform curved mirror 20 are set such that only one of the focal distances intermediately forms an image between the freeform curved mirror 20 and the freeform curved mirror 30. The focal distance fx2 and the focal distance fy2 in the freeform curved mirror 30 are set such that the x-axis component and the y-axis component of the projection light reflected by the freeform curved mirror 30 form an image at the same position. Accordingly, the virtual image 60 seen from the viewpoint 50 is an image which the x-axis component and the y-axis component form at the same position, and the virtual image 60 can be appropriately recognized as an image as if it were present at the imaging position. By appropriately setting the curved surface shape of the freeform curved mirror 30, it is also possible to correct an aberration generated in the projection light reflected by the freeform curved mirror 20.

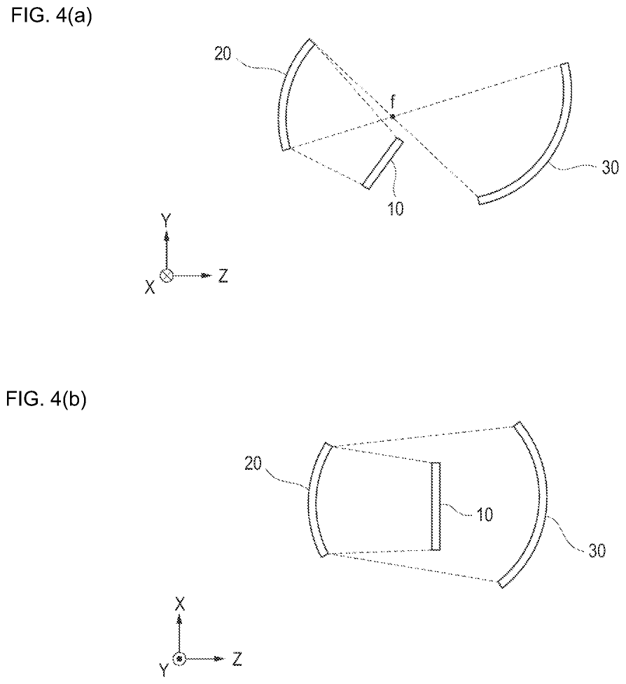

FIG. 4 is a diagram schematically illustrating arrangement of the image projecting unit 10 and the freeform curved mirrors 20 and 30 according to this embodiment, where FIG. 4(a) is a schematic side view and FIG. 4(b) is a schematic top view. As illustrated in FIGS. 4(a) and 4(b), in this embodiment, the y-axis component of the projection light reflected by the freeform curved mirror 20 forms an image at a position f between the freeform curved mirror 20 and the freeform curved mirror 30, and the x-axis component does not form an image.

Accordingly, as indicated by a dotted line in FIG. 4(a), projection light emitted from the whole display surface of the image projecting unit 10 is reflected by the freeform curved mirror 20 and then is focused at the position fin the y-axis direction, and a space for arranging an optical member is present in a space in the y-axis direction between the freeform curved mirror 20 and the freeform curved mirror 30. Accordingly, the image projecting unit 10 can be disposed at a position other than an area in which projection light propagates between the freeform curved mirror 20 and the freeform curved mirror 30. As illustrated in FIG. 4(a), by partially interposing the image projecting unit 10 between the freeform curved mirror 20 and the freeform curved mirror 30, it is possible to effectively use the space to achieve space saving.

When both the x-axis component and the y-axis component of projection light intermediately form an image in the image projection device, aberrations of both the x-axis component and the y-axis component increase and difficulty for correcting the aberrations using the freeform curved mirror 30 increases. In order to cause both the x-axis component and the y-axis component to intermediately form an image, the radii of curvature in the x-axis direction and the y-axis direction of the freeform curved mirror 20 need to be decreased. Accordingly, displacement in a thickness direction of the freeform curved mirror 20 increases and a decrease in size of the image projection device becomes difficult.

On the other hand, in this embodiment, only one of the x-axis component and the y-axis component intermediately forms an image between the freeform curved mirror 20 and the freeform curved mirror 30. Accordingly, regarding an aberration generated with the positive power of the freeform curved mirror 20, only one of the x-axis component and the y-axis component increases and an optical design for correcting the aberration using the freeform curved mirror 30 is simplified. Since the radius of curvature in the x-axis direction or the y-axis direction of the freeform curved mirror 20 can be increased, it is possible to decrease displacement in the thickness direction of the freeform curved mirror 20 and to achieve a decrease in size of the image projection device.

As illustrated in FIG. 4(b), in this embodiment, the center positions in the x-axis direction of the image projecting unit 10 and the freeform curved mirror 20 are substantially matched, and the reference light beam of projection light propagates along a path in only the yz plane and has no displacement in the x-axis direction. Accordingly, it is possible to reduce the aberration of the x-axis component in the freeform curved mirror 20. Since the reference light beam from the freeform curved mirror 30 to the windshield 40 also propagates along a path in only the yz plane and displacement of the y-axis component has only to be considered, it is possible to easily correct the aberration.

As described above, with the image projection device according to this embodiment, since the freeform curved mirror 20 allows only one of the x-axis component and the y-axis component of projection light to form an image between the freeform curved mirror 20 and the freeform curved mirror 30, it is possible to secure a space for arranging an optical member in a space between the freeform curved mirror 20 and the freeform curved mirror 30 and to effectively use the space to achieve space saving. It is possible to easily correct an aberration of the image projection device and to achieve a decrease in size.

### Second Embodiment

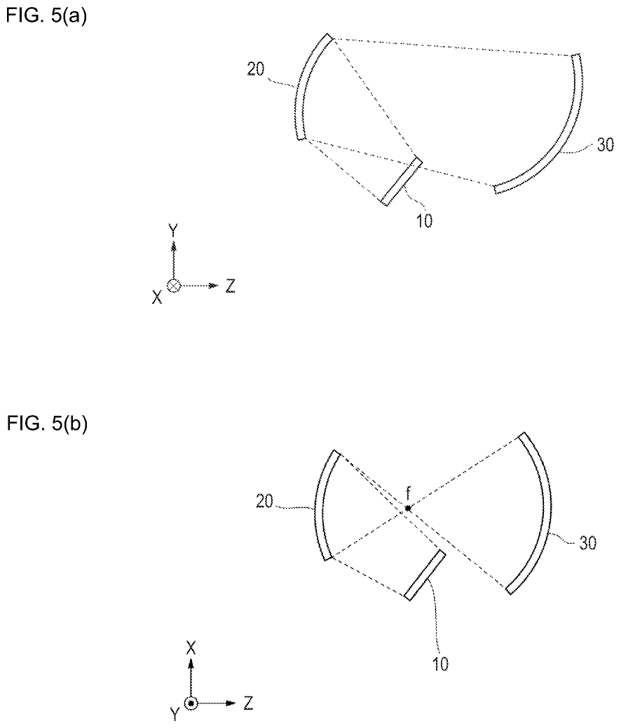

A second embodiment of the invention will be described below with reference to FIG. 5. Description of the same details as in the first embodiment will be omitted. FIG. 5 is a diagram schematically illustrating arrangement of an image projecting unit 10 and freeform curved mirrors 20 and 30 according to this embodiment, where FIG. 5(a) is a schematic side view and FIG. 5(b) is a schematic top view.

As illustrated in FIGS. 5(a) and 5(b), in this embodiment, the x-axis component of projection light reflected by the freeform curved mirror 20 forms an image at a position f between the freeform curved mirror 20 and the freeform curved mirror 30, and the y-axis component does not form an image at that position.

Accordingly, as indicated by a dotted line in FIG. 5(a), projection light emitted from the whole display surface of the image projecting unit 10 is reflected by the freeform curved mirror 20 and then is focused on the position f in the x-axis direction, and a space for arranging an optical member is present in a space in the x-axis direction between the freeform curved mirror 20 and the freeform curved mirror 30. Accordingly, the image projecting unit 10 can be disposed at a position other than an area in which projection light propagates between the freeform curved mirror 20 and the freeform curved mirror 30. As illustrated in FIG. 5(b), by partially interposing the image projecting unit 10 between the freeform curved mirror 20 and the freeform curved mirror 30, it is possible to effectively use the space to achieve space saving.

In this embodiment, the reference light beam is displaced in the x-axis direction between the image projecting unit 10 and the freeform curved mirror 20 and is not displaced in the x-axis direction from the freeform curved mirror 20 to the freeform curved mirror 30, the windshield 40, and the viewpoint 50. Accordingly, correction of an aberration of the x-axis component in the freeform curved mirror 30 becomes more difficult than that in the first embodiment, but since the image projection device often projects an image which is horizontally long, a space which can be secured between the freeform curved mirror 20 and the freeform curved mirror 30 can be enlarged.

The invention is not limited to the aforementioned embodiments and can be modified in various forms within the scope of the claims. Embodiments obtained by appropriately combining technical means disclosed in different embodiments are included in the technical scope of the invention.

This application claims priority to Japanese Patent Application No. 2021-059579 filed on Mar. 31, 2021, incorporated herein by reference in its entirety.

The aforementioned description of specific embodiments of the invention is presented for the purpose of exemplification. The embodiments are not comprehensive nor intended to limit the invention as described. It will be apparent to those skilled in the art that many modifications or alterations thereof are possible in view of the description details.

### REFERENCE SIGNS LIST

10 . . . Image projecting unit
20, 30 . . . Freeform curved mirror
40 . . . Windshield
50 . . . Viewpoint
60 . . . Virtual image

What is claimed is:

1. An image projection device comprising:
an image projecting unit configured to emit projection light including an image;
a first freeform curved mirror reflecting the projection light incident from the image projecting unit; and
a second freeform curved mirror reflecting the projection light incident from the first freeform curved mirror and causing the projection light to reach a viewpoint,
wherein, when an optical path of the projection light from the image projecting unit to the viewpoint is defined as a reference light beam, a reflection direction of the reference light beam from the first freeform curved mirror is defined as a z axis, a direction perpendicular to the z axis in a plane including the reference light beam and the z axis in the second freeform curved mirror is defined as a y axis, and a direction perpendicular to the y axis and the z axis is defined as an x axis,
only one of an x-axis component and a y-axis component of the projection light reflected by the first freeform curved mirror forms an image between the first freeform curved mirror and the second freeform curved mirror.

2. The image projection device according to claim 1, wherein the y-axis component forms an image between the first freeform curved mirror and the second freeform curved mirror.

3. The image projection device according to claim 1, wherein an imaging position of the projection light reflected by the second freeform curved mirror is the same for the x-axis component and the y-axis component.

4. The image projection device according to claim 1, wherein the image projecting unit is disposed at a position other than an area in which the projection light propagates between the first freeform curved mirror and the second freeform curved mirror.

5. The image projection device according to claim 1, further comprising a transmission and reflection part reflecting the projection light incident on one surface from the second freeform curved mirror toward the viewpoint and transmitting external light incident on another surface toward the viewpoint.

6. The image projection device according to claim 5, wherein the transmission and reflection part is a windshield of a vehicle.
